(19) United States
(12) Patent Application Publication
(10) Pub. No.: US 2026/0058468 A1
(43) Pub. Date: Feb. 26, 2026

(54) Reliable Time-Controlled System and Method for Energy Management

(71) Applicant: TTTECH COMPUTERTECHNIK AG, Wien (AT)

(72) Inventor: Hermann KOPETZ, Krumpendorf (AT)

(21) Appl. No.: 19/111,185

(22) PCT Filed: Sep. 11, 2023
(86) PCT No.: PCT/AT2023/060318

§ 371 Date: Mar. 12, 2025

(30) Foreign Application Priority Data
Sep. 13, 2022 (AT) A50703/2022

(51) Int. Cl. H02J 3/14

(52) U.S. Cl. CPC H02J 3/14; H02J 2203/10

(57) ABSTRACT

The invention relates to a reliable system and method for energy management at an end user of electrical energy. The proposed energy management system comprises two substantially independent fault containment units (FCU), an energy steering system (110) and an energy optimization system (150), which exchange data via a well-defined message interface. The energy steering system performs the energy distribution according to the target data (142) periodically received from the energy optimization system. The energy optimization system calculates the optimum use of energy at any given time. Since the energy optimization system has no direct contact with the Internet during normal operation, there can be no intrusion into the energy optimization system. If the energy optimization system fails due to an intrusion, the energy steering system takes over the target data from an contingency/emergency plan stored locally a priori.

The invention relates to a reliable time-triggered system and a method for energy management at an end user of electrical energy.

In particular, the invention relates to an energy management system at an energy end user, wherein the energy management system comprises at least two subsystems, an energy steering system and an energy optimization system, and wherein the energy steering system is connected via power lines to at least one energy source and at least one energy consumer, and is preferably connected to one or more energy storage devices, and performs a time-dependent distribution of the electrical energy in normal operation in accordance with target data from the energy optimization system, and wherein the energy optimization system has algorithms by means of which the time-dependent target data for the distribution of the electrical energy are calculated on the basis of a planned energy consumption and an energy price and weather data downloaded from the Internet.

The invention also relates to a method for energy management at an end user with an energy management system.

The conversion of the energy system from fossil fuels to renewable energy sources, which primarily produce electrical energy, opens up new possibilities for optimizing the use of energy by the end consumer. As the supply of renewable energy-primarily from photovoltaic (PV) systems and wind turbines-depends heavily on the prevailing environmental conditions and is subject to serious fluctuations, it is necessary to store the energy produced by the renewable energy systems in a temporary storage facility so that it can be accessed when energy is needed. Such intermediate storage can either take place at the end consumer (e.g. in a battery) or at the public grid operator (e.g. in a reservoir).

With the introduction of time-dependent electricity tariffs (e.g. KELAG's [KELAG-Kärntner Elektrizitäts-Aktiengesellschaft] “Sonnenplus Smart” tariff), grid operators are attempting to pass on the costs of energy storage to the end consumer. This gives the end consumer the opportunity to save energy costs through intelligent energy management. For example, an end consumer with a local energy storage system can shift energy consumption from the electricity grid to a time when the electricity tariff is low and—especially if he has a local energy source such as a PV system—shift the energy supply to the electricity grid to a time when a high electricity tariff can be expected.

This type of energy optimization requires complex computer systems that use weather data and tariff forecasts from the Internet and the estimated local energy demand to optimally control the flow of electrical energy to the end user. These complex dynamic computer systems, which must be connected to the Internet, are less reliable than simple systems without a direct connection to the Internet, which control the energy flow according to fixed static rules.

It is an object of the present invention to increase the reliability of energy management at the end user.

This object is achieved with a system mentioned at the beginning in that the energy steering system and the energy optimization system each form an independent fault containment unit, and wherein an interface between the energy steering system and the energy optimization system is designed as a time-triggered message interface, and wherein a well-defined time-triggered message with the target data of the energy distribution in the following period is periodically sent from the energy optimization system to the energy steering system, and wherein a well-defined time-triggered message with the actual data of the energy use in the previous period is periodically sent from the energy steering system to the energy optimization system, and wherein a contingency plan with target data for energy distribution is present in the energy steering system, which is used by the energy steering system if no well-defined message with target data for energy distribution arrives at the energy steering system from the energy optimization system within a defined time interval, or if the received values of the target data do not lie within a priori specified value ranges of the well-defined messages, and wherein a switch is present in the energy steering system with which the connection to the Internet can be switched off.

Likewise, this object is achieved with a method mentioned at the beginning in that a well-defined time-triggered message with the target data of the energy distribution in the following period is periodically sent from the energy optimization system to the energy steering system, and wherein a well-defined time-triggered message with the actual data of the energy use in the past period is periodically sent from the energy steering system to the energy optimization system, and wherein a contingency plan with target data for energy distribution is present in the energy steering system, which is used by the energy steering system if no well-defined message with target data for energy distribution arrives at the energy steering system from the energy optimization system within a defined time interval, or if the received values of the target data are not within a priori specified value ranges of the well-defined messages, and wherein a switch is present in the energy steering system with which the connection to the Internet can be switched off.

The energy optimization system therefore sends target data to the energy steering system in a period under consideration, which is to be used in the period following this period under consideration.

Furthermore, the energy steering system sends actual data of the energy use in a period under consideration to the energy optimization system in the period preceding the period under consideration.

The object of the invention is thus achieved by dividing the energy management system at the end user into at least two subsystems. The first, preferably highly reliable, subsystem with preferably simple software and in normal operation without an active Internet connection—the energy steering system—carries out the energy steering. The second subsystem, preferably with complex software and an Internet connection—the energy optimization system—calculates the optimum energy use at any given time. The transfer of the target data and the actual data of the energy use takes place through the transmission of well-defined messages between these two subsystems. A message is well-defined if its structure and the permitted value ranges of the data are specified a priori.

According to the invention, both subsystems are fault containment units (FCU). A fault containment unit (FCU) is a self-contained computer system comprising hardware and software that communicates with its environment via well-defined messages. An internal failure of an FCU, whether caused by a temporary or permanent hardware failure, a design error in the software or an intrusion, will in most cases result in the failure of an expected message and in a few cases in the transmission of a message containing implausible data.

From a reliability perspective, every active internet connection represents a risk that should not be underestimated, as an intrusion can occur via such an active internet connection. Sophisticated intrusion-detection algorithms can reduce this risk, but not completely eliminate it. No intrusion into the energy steering system can take place via the well-defined messages that are sent via the interface between the energy optimization system and the energy steering system. According to the invention, an existing Internet connection of the energy steering system, which is required for maintenance purposes, can be deactivated by a switch on the energy steering system, so that no intrusion into the energy steering system can take place via the Internet during normal operation.

A time-triggered communication system recognizes the failure of a message within a minimum error detection latency. Faulty data can be detected by a plausibility check of the received data at the receiver. In accordance with the invention, the reliable energy steering system accesses a static emergency plan/contingency plan, which is available in the energy steering system, after the failure of a message or the receipt of faulty data. In this way, the energy supply to the end user is maintained even in the event of a fault or an intrusion into the energy optimization system.

Advantageous embodiments of the system and method according to the invention are explained in the dependent claims.

It may be useful if the time-triggered messages exchanged between the subsystems contain data from at least three consecutive periods.

It may be advantageous if the data traffic between the energy steering system and the energy optimization system is handled via a wired or wireless communication channel.

It may be useful for the data traffic on the interface between the energy steering system and the energy optimization system to be observed by an independent monitor, whereby this observation does not influence the flow and timing of the data traffic between the energy steering system and the energy optimization system.

Furthermore, it can be advantageous if the energy optimization system operates a direct or indirect man/machine interface via which the energy consumption can be queried and on which, if no message with the actual data of the energy use from the energy steering system arrives at the energy optimization system within a defined time interval, an alarm message is sent from the energy optimization system to the man/machine interface.

It can be advantageous if the energy optimization system controls the energy consumption of one or more appliances at an end user.

Finally, it can be an advantage if the energy optimization system has an Internet connection and intrusion detection algorithms.

### EXPLANATION OF TERMS USED

The following is the assumed meaning of important terms used in the description.

Energy steering system: A fault containment unit that distributes energy during normal operation according to the target data received from the energy optimization system. An energy steering system essentially corresponds to a standard PV inverter with the crucial difference that any internet connection present can be deactivated by a switch during normal operation.

Energy optimization system: A fault containment unit that has an Internet connection and calculates the optimal use of energy under the given market conditions, the predicted weather conditions and the planned energy consumption at the end consumer and periodically sends the corresponding target data to the energy steering system via a well-defined data interface.

Fault containment unit: An encapsulated computer system comprising hardware and software that exchanges well-defined messages with its environment.

Fault detection latency: The time interval between the occurrence of a fault and the detection of a fault.

Failure: Failure of communication between the energy optimization system and the energy steering system.

Actual data: The data on the energy use that has taken place in a specified period.

Intrusion: An intrusion (successful hacker attack) into a computer system.

Intrusion-detection algorithm: An algorithm with which an intrusion can be detected.

Normal operation: A state during which the energy steering system, the energy optimization system and the data transmission between these systems function as specified.

Emergency plan: A data structure in the energy steering system that specifies how energy distribution should be handled in the energy steering system if no plausible target data is received from the energy optimization system.

Plausible data: Data that lies within the permitted value ranges of a well-defined message. Data that is not within the permitted value ranges of a well-defined message is incorrect.

Signal line: Wired or wireless channel for transmitting data.

Control signal: A signal for controlling a device.

Target data: Data that specifies the energy control/steering in a specified period.

Power line: Line for the transmission of electrical energy.

Well-defined message: A message in which the structure and the permitted value ranges of the data are specified a priori.

Well-defined time-triggered message: A well-defined message whose periodic reception times are specified.

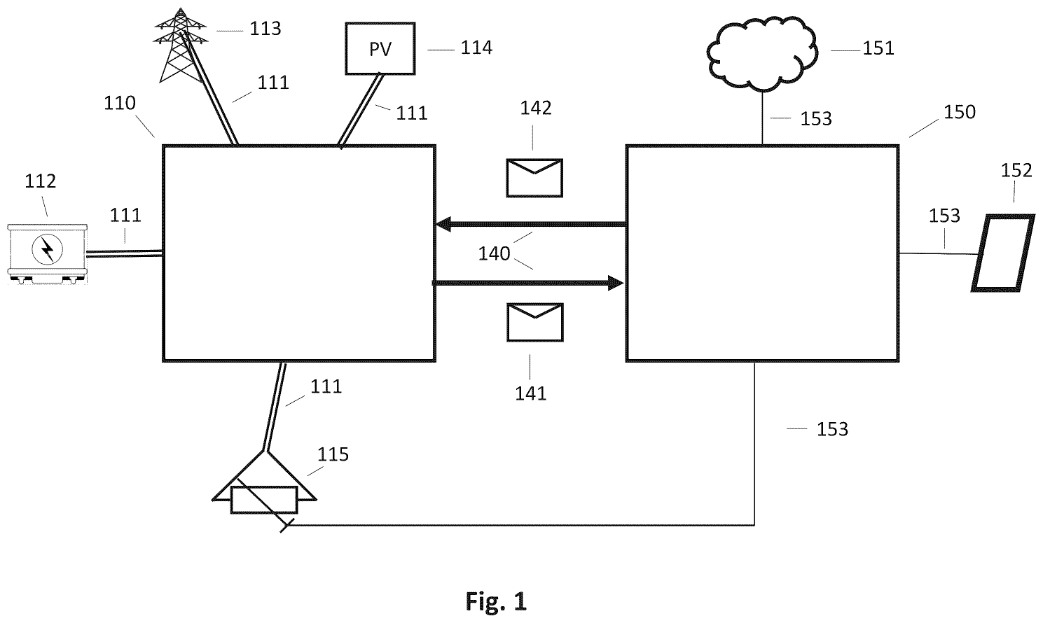

The invention is discussed in more detail below with reference to FIG. 1.

FIG. 1 shows a possible realization of an energy management system for an energy end consumer. The concrete realization shown and described represents only one of many possible implementations of the invention.

FIG. 1 shows an energy steering system 110 in the center left, which is connected via the wireless or wired communication channel 140 to the energy optimization system 150 in the center right of FIG. 1. The periodically well-defined messages with the actual data 141 and the target data 142 are transmitted via this communication channel 140. In order to be able to tolerate the transient failure of two consecutive messages, the message 141 contains the actual data of at least three of the past periods and the message 142 contains the target data for at least three of the following periods.

According to the invention, the actual data 141 and desired data 142 on the communication channel 140 can be observed by an independent monitor without affecting the flow and timing of data traffic between the energy steering system 110 and the energy optimization system 150.

The power lines 111, on which electrical energy can be transmitted, lead from the energy steering system 110 to a battery 112, to the public electrical grid 113, to a photovoltaic (PV) system 114 and to the end consumers 115. The desired power of the end consumers 115 can be dynamically determined by the energy optimization system 150 via the wireless or wired signal line 153. The switch 116, which can be used to deactivate the Internet connection during normal operation, is located on the energy steering system 110.

Wireless or wired signal lines 153, on which messages can be transmitted, lead from the energy optimization system 150 to the cloud 151, in which the long-term storage of the data takes place, to a man/machine interface 152 and to the end users 115.

The man/machine interface 152 can be established via a mobile phone. The man/machine interface 152 can be used to query the energy consumption and determine the planned energy outputs of the end users. If the energy optimization system 150 does not receive a message with the actual energy usage data from the energy steering system 110 within a defined time interval, the energy optimization system 150 sends an alarm message to the human/machine interface.

In normal operation, the energy optimization system 150 retrieves the current weather data and the price data of the grid energy via the signal line 153 and receives the desired energy use from the user via the man/machine interface 152. The actual data 141 on energy generation and energy use in the previous period are supplied by the energy steering/control system 110 via the communication channel 140. From all this data, the energy optimization system 150 calculates the optimal energy use in the following period and sends this target data 142 to the energy steering system 110, which performs the specified energy distribution.

The energy optimization system 150 includes intrusion-detection algorithms to detect and defend against an attempted intrusion into the energy optimization system 150.

An error occurs if the energy optimization system 150 or the communication channel 140 between the energy steering system 110 and the energy optimization system 150 has failed or if the energy steering system 110 receives messages 142 with values that lie outside the specified value ranges of the well-defined messages. In this case, the energy steering system 110 adopts the target data from an emergency/contingency plan of the energy steering system 110 and controls the energy flow according to this contingency plan.

1. An energy management system at an energy end user, wherein the energy management system comprises:
at least two subsystems,
an energy steering system (110), and
an energy optimization system (150),
wherein the energy steering system (110) is connected via power lines (111) to at least one energy source (112, 113, 114) and at least one energy consumer (115), and is preferably connected to one or more energy storage devices (112), and performs a time-dependent distribution of the electrical energy in normal operation in accordance with target data (142) from the energy optimization system (150),
wherein the energy optimization system (150) has algorithms by means of which the time-dependent target data (142) for the distribution of the electrical energy is calculated on the basis of a planned energy consumption and an energy price and weather data downloaded from the Internet,
wherein the energy steering system (110) and the energy optimization system (150) each form an independent fault containment unit,
wherein an interface between the energy steering system and the energy optimization system is designed as a time-triggered message interface, and wherein a well-defined time-triggered message with the target data of the energy distribution in the following period is periodically sent from the energy optimization system (150) to the energy steering system (110), and wherein a well-defined time-triggered message with the actual data (141) of the energy use in the past period is periodically sent from the energy steering system to the energy optimization system,
wherein a contingency plan with target data for energy distribution is present in the energy steering system (110), which is used by the energy steering system if no well-defined message with target data for energy distribution is received by the energy steering system from the energy optimization system in a specified time interval, or if the received values of the target data are not within a priori specified value ranges of the well-defined messages, and
wherein a switch (116) is provided in the energy steering system (110) with which the connection to the Internet can be switched off.

2. The energy management system according to claim 1, wherein the time-triggered messages exchanged between the subsystems (110, 150) comprise the data of at least three consecutive periods.

3. The energy management system according to claim 1, wherein the data traffic between the energy steering system (110) and the energy optimization system (150) is handled via a wired or wireless communication channel (140).

4. The energy management system according to claim 1, wherein the data traffic on the interface between the energy steering system and the energy optimization system is observed by an independent monitor, wherein said observation does not influence the flow and timing of the data traffic between the energy steering system and the energy optimization system.

5. The energy management system according to claim 1, wherein the energy optimization system operates a direct or indirect man/machine interface (152) via which the energy consumption can be queried and on which, if no message with the actual data of the energy use from the energy steering system arrives at the energy optimization system within a defined time interval, an alarm message is sent by the energy optimization system to the man/machine interface.

6. The energy management system according to claim 1, wherein the energy optimization system (150) controls the energy consumption of one or more appliances at an end user.

7. The energy management system according to claim 1, wherein the energy optimization system (150) has an internet connection (153) and intrusion detection algorithms.

8. A method for energy management at an end user with an energy management system according to claim 1, wherein a well-defined time-triggered message with the target data of the energy distribution in the following period is periodically sent from the energy optimization system (150) to the energy steering system (110), wherein a well-defined time-triggered message with the actual data of the energy use in the past period is periodically sent from the energy steering system to the energy optimization system, wherein a contingency plan with target data for energy distribution is present in the energy steering system, which is used by the energy steering system if no well-defined message with target data for energy distribution arrives at the energy steering system from the energy optimization system in a specified time interval, or if the received values of the target data are not within a priori specified value ranges of the well-defined messages, and wherein a switch is provided in the energy steering system with which the connection to the Internet can be switched off.

9. The method according to claim 8, wherein the time-triggered messages exchanged between the subsystems contain the data of at least three consecutive periods.

10. The method according to claim 8, wherein the data traffic on the interface between the energy steering system and the energy optimization system is observed by an independent monitor, wherein this observation does not influence the flow and timing of the data traffic between the energy steering system and the energy optimization system.

11. The method according to claim 8, wherein the energy optimization system operates a direct or indirect man/machine interface (152) via which the energy consumption can be queried and on which, if no message with the actual data of the energy use is received by the energy optimization system from the energy steering system within a predetermined time interval, an alarm message is sent by the energy optimization system to the man/machine interface.

12. The method according to claim 8, wherein the energy optimization system controls the energy consumption of one or more appliances at an end user (115).
